(19) United States
(12) Patent Application Publication
(10) Pub. No.: US 2005/0057677 A1
(43) Pub. Date: Mar. 17, 2005

(54) Digital camera and method of controlling the same

(76) Inventors: Tsuyoshi Hagiwara, Ome-shi (JP); Tatsuhiko Ikehata, Ome-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/936,594

(22) Filed: Sep. 9, 2004

(30) Foreign Application Priority Data
Sep. 11, 2003 (JP) 2003-319978

(51) Int. Cl. H04N 5/222

(52) U.S. Cl. 348/333.01

(57) ABSTRACT

A digital camera comprises an optical mechanism and display unit. The optical mechanism includes an optical zooming device having a zooming lens, and a focus-moving optical device having a focusing lens. The display unit can display a focal-distance scale that indicates a range of focal distance, which is appropriated for any magnification set by a user, one end of the focal-distance scale representing a shortest camera-to-object distance and the other end of the focal-distance scale representing an infinite camera-to-object distance.

### CROSS-REFERENCE TO RELATED APPLICATIONS

This application is based upon and claims the benefit of priority from prior Japanese Patent Application No. 2003-319978, filed Sep. 11, 2003, the entire contents of which are incorporated herein by reference.

### BACKGROUND OF THE INVENTION

1. Field of the Invention

The present invention relates to a digital camera and a method of controlling the digital camera.

2. Description of the Related Art

In recent years, digital cameras that acquire video data and write the data in a recording medium have been developed. The digital camera includes a zooming lens, a focusing lens, an electronic viewfinder, a liquid crystal display (LCD), and various switches. The digital camera can operate in two modes (see, for example, Jpn. Pat. Appln. KOKAI Publication 2002-51239). The first mode is automatic focusing (AF) mode. The second mode is manual focusing mode. The camera is set in the automatic focusing mode or manual focusing mode to photograph any object at a desired magnification.

When the user sets the digital camera in the manual focusing mode, the LCD displays a zooming gauge and a focal-distance scale. Generally, the focal distance is shorter for magnification 1 (indicated at the WIDE end the zooming gauge) than for a high magnification (indicated at a point near the TELE end of the zooming gauge). This is why the shortest focal distance is indicated at the WIDE end of the zooming gauge. Here arises a problem. If the focal distance is displayed very near the TELE end of the zooming scale, the end of the focal-distance scale will be too far from the point representing the shortest focal distance.

Due to the characteristic of the focusing lens, the focal distance is not proportional to the distance the focusing lens is moved. (In other words, the focal distance does not change linearly with the distance the lens moves). Hence, the focal distance changes less at the WIDE end of the zooming gauge than at the TELE end thereof, particularly when the magnification selected is great.

Thus, the focal-distance scale should be displayed so that its greater part indicates relatively short focal distances. No prominent problems will arise in actual photographing if the focal-distance scale is so displayed and if magnification of about 3 is indicated at the TELE end of the zooming gauge.

If the camera incorporates a high-power zooming lens, however, only one third of the focusing gauge is used, and the remaining two thirds remain almost unused. Namely, the use efficiency of the focusing gauge is low. Further, it is difficult for the user to determine the focal distance against the focusing gauge. In short, the focusing gauge is not so useful.

### BRIEF SUMMARY OF THE INVENTION

A digital camera according to an aspect of the invention comprises an optical mechanism and display unit. The optical mechanism includes an optical zooming device having a zooming lens, and a focus-moving optical device having a focusing lens. The display unit can display a focal-distance scale that indicates a range of focal distance, which is appropriated for any magnification set by a user, one end of the focal-distance scale representing a shortest camera-to-object distance and the other end of the focal-distance scale representing an infinite camera-to-object distance.

According to another aspect of the invention, there is provided a method of controlling a digital camera that comprises display unit, and an optical mechanism including an optical zooming device and a focus-moving optical device, the method comprising:
causing the display unit to display a focal-distance scale that indicates a focal-distance range appropriated for any magnification set by a user, one end of the focal-distance scale representing a shortest camera-to-object distance and the other end of the focal-distance scale representing the infinite camera-to-object distance.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is the first half of a flow chart illustrating a method of displaying a focusing gauge according to an embodiment of this invention;

FIG. 2 is the second half of the flow chart;

FIG. 3 is a flowchart representing a method of switching the zooming to the focusing, and vice versa;

FIG. 4 is a perspective view of a digital camera according to the invention, as viewed from the front;

FIG. 5 is a plan view of the mode dial that is provided on the digital camera shown in FIG. 4;

FIG. 6 is a perspective view of the digital camera shown in FIG. 4, as viewed from the back of the camera and somewhat below;

FIG. 7 is a block diagram showing the optical section and electric section of the digital camera shown in FIG. 4 and 6;

FIG. 8 shows a zooming gauge displayed on the screen of the display provided on the camera;

FIG. 9 is a magnified view of the zooming gauge;

FIG. 10 depicts a focusing gauge that is displayed to help the user to set a desired focal distance;

FIG. 11 is a graph showing the relation between the focal distance and the magnification; and

FIG. 12 shows various focal-distance scales that can be displayed at the focusing gauge.

### DETAILED DESCRIPTION OF THE INVENTION

A digital camera, which is an embodiment of this invention, and a method of controlling this camera will be described below, with reference to the accompanying drawings.

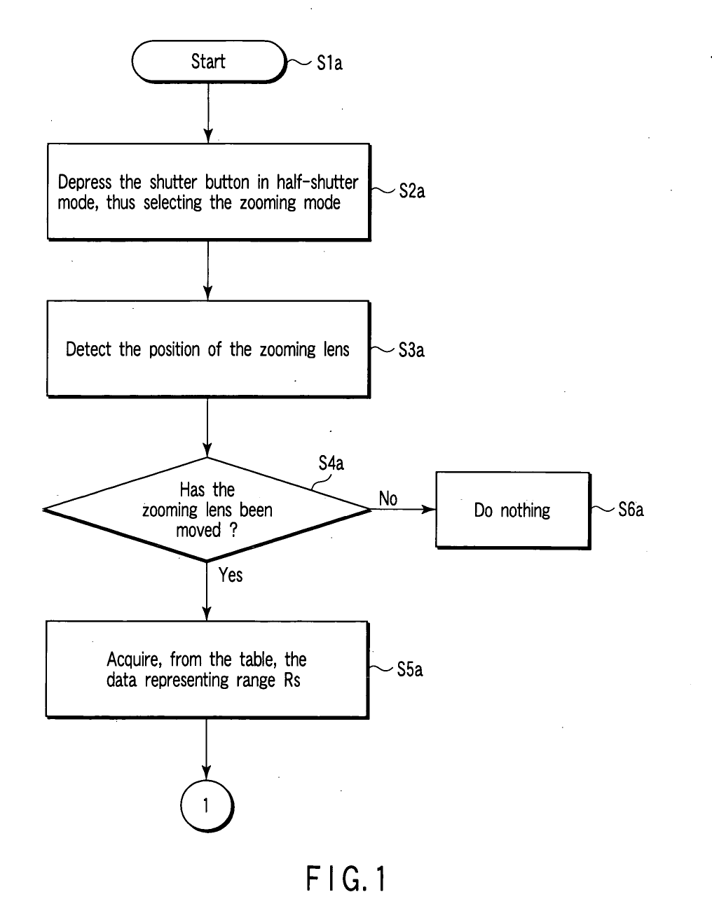

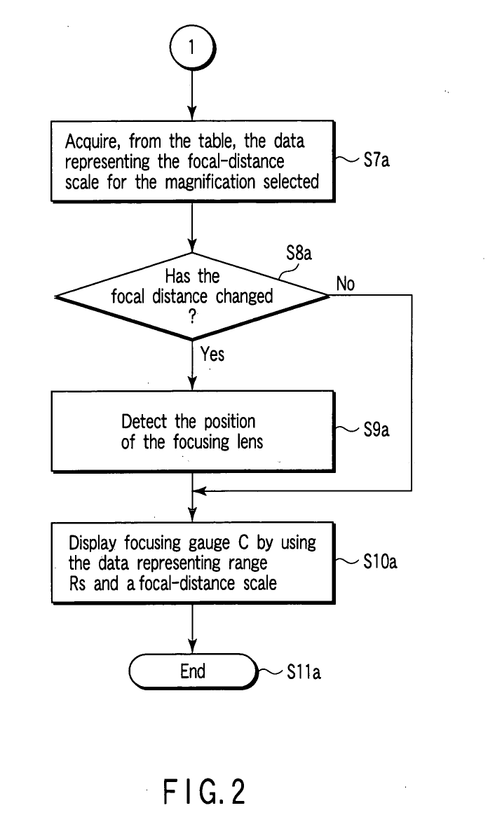

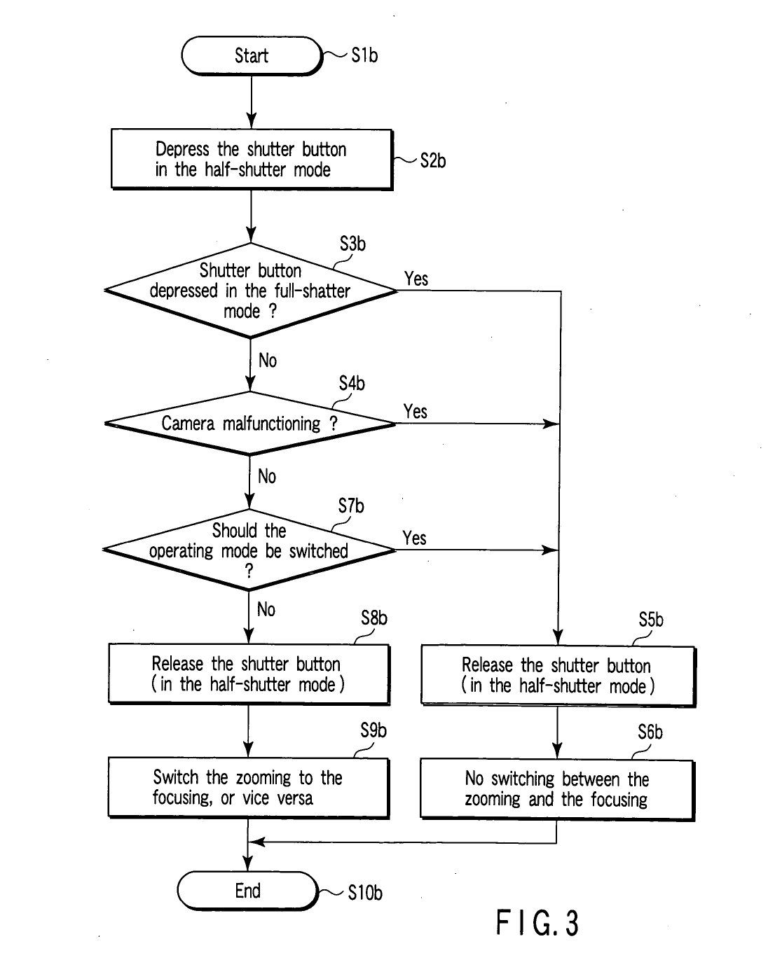

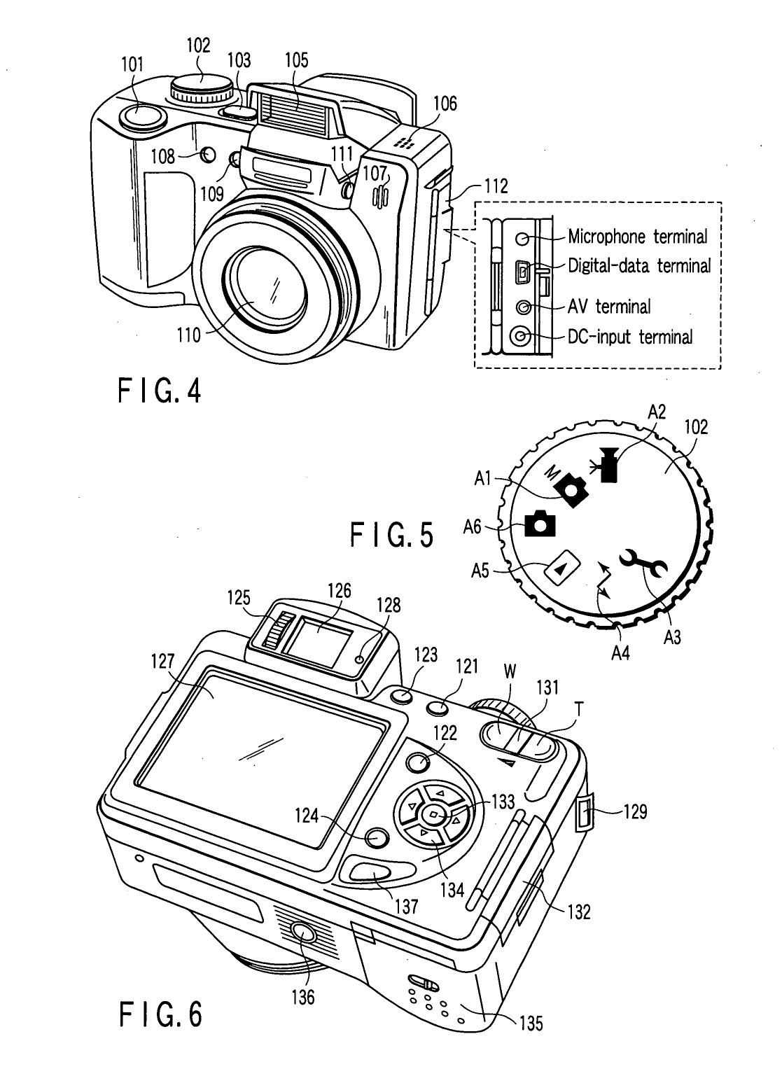

FIGS. 1 and 2 are a flowchart, and FIG. 3 is a flowchart, too. The flowcharts explain how the digital camera operates. The camera will be described, first with reference to FIGS. 4 to 6, to facilitate the understanding of the camera as a whole.

FIG. 4 is a perspective view of the digital camera, as viewed from the front. FIG. 6 is a perspective view of the digital camera, as viewed from the back of the camera and somewhat below.

As FIG. 4 shows, the digital camera has a shutter button 101, a mode dial 102, a power switch 103, and a display unit 104, all provided on the camera body. The shutter button 101, or the first input means, can be pushed in two modes, i.e., half-shutter mode and full-shutter mode. The display unit 104 is called “front LED” that displays the mode in which the digital camera is operating. The digital camera further has a flash lamp 105, a speaker 106, a microphone 107, a remote-control light-receiving unit 108, a flashlight sensor 109, and a lens system 110. The remote-control light-receiving unit 108 is provided to receive optical signals emitted from a remote controller (not shown).

The digital camera has a flash-open button 111 and a terminal cover 112. The terminal cover 112 may be opened to expose an external-microphone terminal, a digital-data terminal, an AV terminal and a DC-input terminal.

FIG. 5 is a plan view of the mode dial 102. The mode dial 102 has icons A1 to A6 printed on it. The icons A1 to A6 represent various modes in which the camera can operate. More specifically, icon A1 represents the manual-photographing mode (in which the white balance, exposure time, diaphragm opening, shutter speed, and the like can be manually controlled). Icon A2 represents the moving-picture mode (in which a moving picture can be photographed). Icon A3 represents the setup mode (in which the basic setups of the camera, e.g., sound, automatic power-off, customizing, language, video-data output, date and system mode).

The user may turn the dial 102 to set the camera in the manual-photographing mode. Once the camera has been set in the manual-photographing mode, the user can manually set a desired optical zooming position (hereinafter referred to as “zoom position”) and a focal distance appropriate for the zoom position. The zoom position indicates the magnification at which the object is to be photographed. The zoom position can be changed to represent a magnification ranging from 1 to 10.

Icon A4 represents the PC mode (in which video data is input to personal computers). Icon A5 represents the reproduction mode, and icon A6 represents the automatic photographing mode.

The user may turn the mode dial 102, moving one of icons A1 to A6 to the above-mentioned specified position, thereby to select the operating mode that the icon represents.

As FIG. 6 shows, a flash button 121, a menu button 122, a self-timer remote-control button 123, an erase button 124, and a visibility-adjusting dial 125 are arranged on the back of the camera. An electronic viewfinder 126 and a liquid crystal display 127 are provided on the back of the camera, too. The liquid crystal display 127 has a screen larger than that of the electronic viewfinder 126, which is a liquid crystal display, too. The liquid crystal display 127, or display unit, will be called “LCD panel” so that it may be distinguished from the electronic viewfinder (EVF).

A finder LED 128 is arranged besides the EVF 126. The finder LED 128 may emit light to informing the user that the EVF 126 is on. A shoulder-strap holder 129 is secured to one side of the camera. Moreover, a TELE/WIDE button 131, an OK button 133 and selection buttons 134 are provided on the back of the camera. When operated, the TELE/WIDE button 131, or second input means, sets a degree of zooming. The TELE/WIDE button 131 includes two buttons W and T and is used to set a desired focal distance, too. The When pushed, each selection button 134 selects a menu items or an image. A card cover 132 is provided to one side of the camera. A battery cover 135 is provided on the bottom of the camera. A screw hole 136 is cut in the bottom of the camera, to hold the top of a tripod.

A display button 137 is arranged on the back of the camera. The display button 137 may be depressed to switch the display from the LCD 127 to the EVF 126, or vice versa. When pushed rather long, the display button 1037 sets the EVF 126 and the LCD 127 in sleep mode to save the battery power. The LCD 127 has a size ranging from 1.5 to 2.5 inches, as most display units of this type. By contrast, the EVF 126 is a small peeping window.

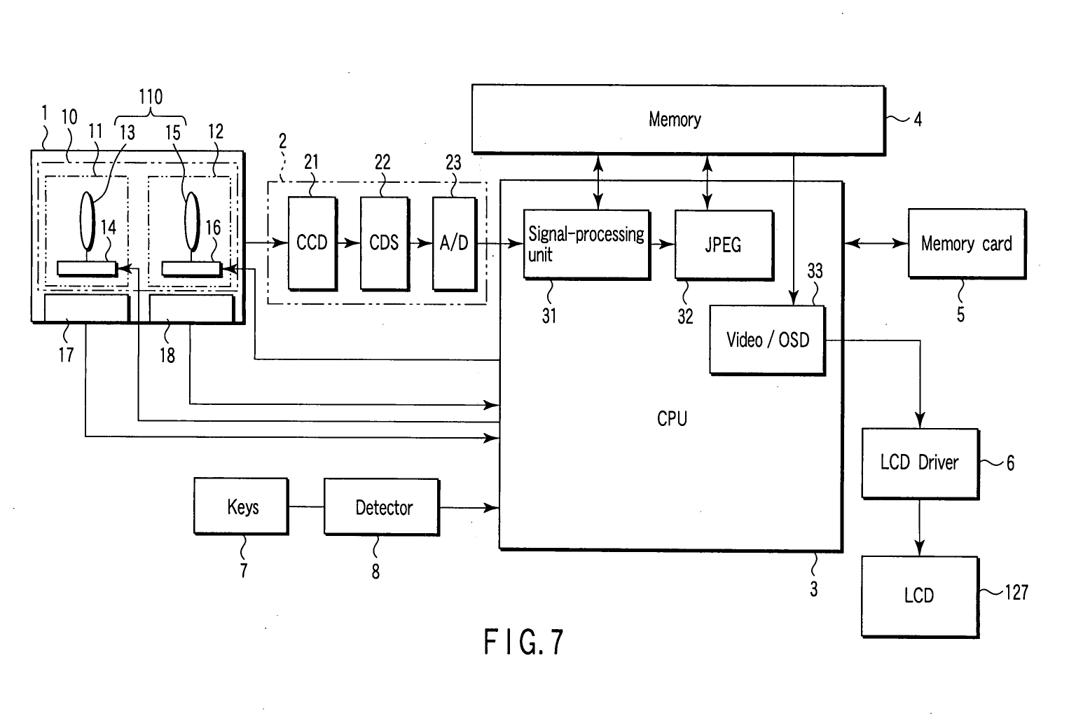

FIG. 7 is a block diagram showing the optical section and electric section of the digital camera. As is illustrated in FIG. 7, the digital camera incorporates a lens module 1, a CCD/CDS/AD circuit 2, a central processing unit (CPU) 3, a memory circuit 4, a memory card 5, an LCD driver 6, keys 7, and detector 8, in addition to the LCD 127. The memory card 5 is a nonvolatile recording medium. The LCD driver 6 is a drive circuit. The keys 7 are used as an switching portion. The memory card 5 can be removed from the digital camera. In this embodiment, the keys 7 include the shutter button 101 (i.e., first input means) and the TELE/WIDE button 131 (i.e., second input means).

A detector 8 is provided, which detects the data input by operating the keys 7. The detector 8 can also detect whether the shutter button 101 has been pushed in the half-shutter mode or the full-shutter mode.

The lens module 1 incorporates an optical system 10. The optical system 10 includes an optical zooming device 11 and an optical focal-point moving device 12.

The optical zooming device 11 has a zooming lens 13 and a zooming motor 14. The zooming lens 13 comprises a plurality of lenses. The zooming motor 14 is drive means for changing the intervals between the lenses. The optical zooming device 11 can therefore its focal distance changed. Hence, the optical zooming device 11 serves to photograph an object at various magnifications.

The optical focal-point moving device 12 has a focusing lens 15 and a focusing motor 16. The focusing motor 16 is drive means for moving the focusing lens 15. The optical focal-point moving device 12 can therefore set a focal distance at various. The lens system 110 has the zooming lens 13 and the focusing lens 15. The CPU 3 controls the zooming motor 14 and the focusing motor 16.

The lens module 1 further incorporates a first detecting unit 17 (i.e., first detecting means) and a second detecting unit 18 (i.e., second detecting means). The first detecting unit 17 detects a change in the position of the zooming lens 13 and generates position data representing the new position of the zooming lens 13. The position data is supplied to the CPU 3. From the position data, the CPU 3 therefore determines that the magnification has been changed to any value that ranges from 1 to 10. Similarly, the second detecting unit 18 detects a change in the position of the focusing lens 15 and generates position data representing the new position of the focusing lens 15. This position data is supplied to the CPU 3. From this data, the CPU 3 determines that the focal distance has changed.

The CCD/CDS/AD circuit 2 includes a charge-coupled device (CCD) 21, a correlative double-sampling (CDS) circuit 22, and an analog-to-digital (A/D) conversion circuit 23. The CDS circuit 22 is designed to remove noise from the signal supplied to it from the CCD 21.

The CPU 3 includes a signal-processing unit 31, a JPEG compressing circuit 32 and a Video/OSD circuit 33. The JPEG compressing circuit 32 is a data-processing circuit for compressing data (video signals). The Video/OSD circuit 33 is a data-processing unit for generating video data that represents an image. The circuit 33 supplies a video signal to the LCD driver 6, which drives the LCD 127. Driven by the driver 6, the LCD 127 displays a zooming tab and a focal distance, both selected by the user.

It will be described how the digital camera described above operates to photograph an object.

First, the light reflected by the object travels through the lens module 1 to the CCD 21, forming an optical image of the object on the image-forming surface of the CCD 21. The CCD 21 changes the optical image into an electric video signal. The video signal is supplied via the CDS circuit 22 to the A/D conversion circuit 23. The A/D conversion circuit 23 converts the video signal to a digital video signal. The digital video signal is supplied to the signal-processing unit 31 provided in the CPU 3. The signal-processing unit 31 performs gamma correction, extracts color signals from the video signal, and adjusts the white balance.

Assume that the user has not pushed the shutter button 101 in the full-shutter mode in the normal photographing conditions. In this case, the video signal is supplied from the signal-processing unit 31 to the LCD 127 through the memory circuit 4, the Video/OSD circuit 33 and the LCD driver 6. The LCD 127 displays the image of the object, which the lens module 1 has received.

When the user pushes the shutter button 101 in the full-shutter mode, the video signal is transferred from the signal-processing unit 31 to the memory card 5 through the JPEG compressing circuit 32 and the memory circuit 4. Thus, the memory card 5 stores the video signal compressed by the JPEG compressing circuit 32. The video signal is supplied from the signal-processing unit 31 to the LCD 127, too, via the memory circuit 4, Video/OSD circuit 33 and LCD driver 6. The LCD 127 displays the image of the object.

The video signal stored in the memory card 5 is compressed. This compressed video signal is read from the card 5 into the CPU 3. In the CPU 3, a data-expanding unit (not shown) expands the video signal. The video signal, thus expanded, is supplied to the LCD 127 through the LCD driver 6. Thus, the LCD 127 displays the image that is represented by the video signal stored in the memory card 5.

How the digital camera operates in the in the manual focusing mode will be explained. Assume that the user sets the camera in the manual focusing mode to photograph the object. Then, the user set a desired magnification at which to photograph the object, as will be described below.

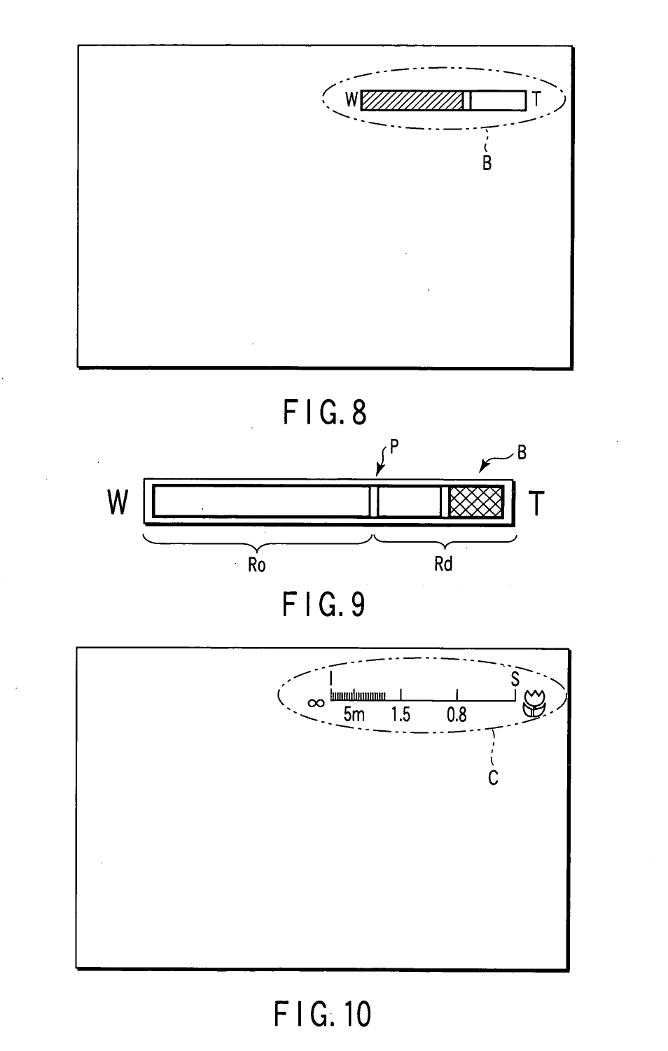

When the camera is set in the manual focusing mode, the LCD 127 displays a zooming gauge B as is illustrated in FIG. 8. The zooming gauge B, which is an OSD image, indicates the magnification at which the object is photographed. The WIDE end and TELE end of the gauge B indicate the magnification of 1 and the maximum magnification of 10.

To change the magnification, the user pushes the TELE/WIDE button 131 shown in FIG. 6 (i.e., one of the keys 7 shown in FIG. 7). More precisely, the user depresses the button W to decrease the magnification, or the button T to increase the magnification. The data representing the magnification, which is being changed, is supplied to the CPU 3 and thence to the LCD 127 through the Video/OSD circuit 33 and LCD driver 6. Hence, the magnification slider on the zooming gauge B displayed on the LCD 127 extends toward the WIDE end of the gauge B, which indicates the magnification of 1, or toward the TELE end of the gauge B, which indicates the magnification of 10.

The zooming gauge B will be described in detail.

As FIG. 9 shows, the zooming gauge B includes an optical zooming region Ro, a digital zooming region Rd, and a boundary region P. The region Ro indicates the optical magnification that may range from 1 to 10. The region Rd indicates a digital magnification ranging from 1 to 10. The boundary region P lies between the regions Ro and Rd and indicates the maximum optical magnification of 10. Namely, the TELE end of the gauge B does not indicate the maximum optical magnification. The digital zooming, which does not characterize this embodiment, will not be described.

It will be described how a desired focal distance is set in the digital camera operating in the manual focusing mode, after a desired optical magnification has been set as described above.

When the desired optical magnification is set in the camera, the LCD 127 displays a focusing gauge C, which is an OSD image, as illustrated in FIG. 10. The focusing gauge C displays the focal distance. The gauge C consists of a scale and a slider. The scale has some graduations of 5 m, 1.5 m and 0.8 m. The slider indicates the infinite focal distance when it is at the left end I of the scale. It indicates the shortest focal distance when it is at the right end S of the scale.

To change the focal distance, the user pushes the TELE/WIDE button 131 shown in FIG. 6 (i.e., one of the keys 7 shown in FIG. 7). More specifically, the user may depress the button W to increase the focal distance, or the button T to decrease the magnification. The data representing the focal distance being changed thus is supplied to the CPU 3 and thence to the LCD 127 through the Video/OSD circuit 33 and LCD driver 6. Hence, the magnification slider on the focusing gauge C displayed on the LCD 127 contracts toward the left end I of the scale, which indicates the infinite distance, or extends toward the right end S of the scale, which indicates the shortest focal distance.

Thus, the TELE/WIDE button 131 is used not only to change the magnification to accomplish zooming, but also to perform manual focusing. To switch the function of the button 131, from the zooming to the manual focusing and vice versa, the user pushes the shutter button 101 in the half-shutter mode.

To be more specific, the CPU 3 switches the function of the button 131 is switched, from the zooming and the focusing, or vice versa, in accordance with the data that the detector 8 has detected. Further, the CPU 3 causes the LCD 127 to display the function of the button 131 thus switched.

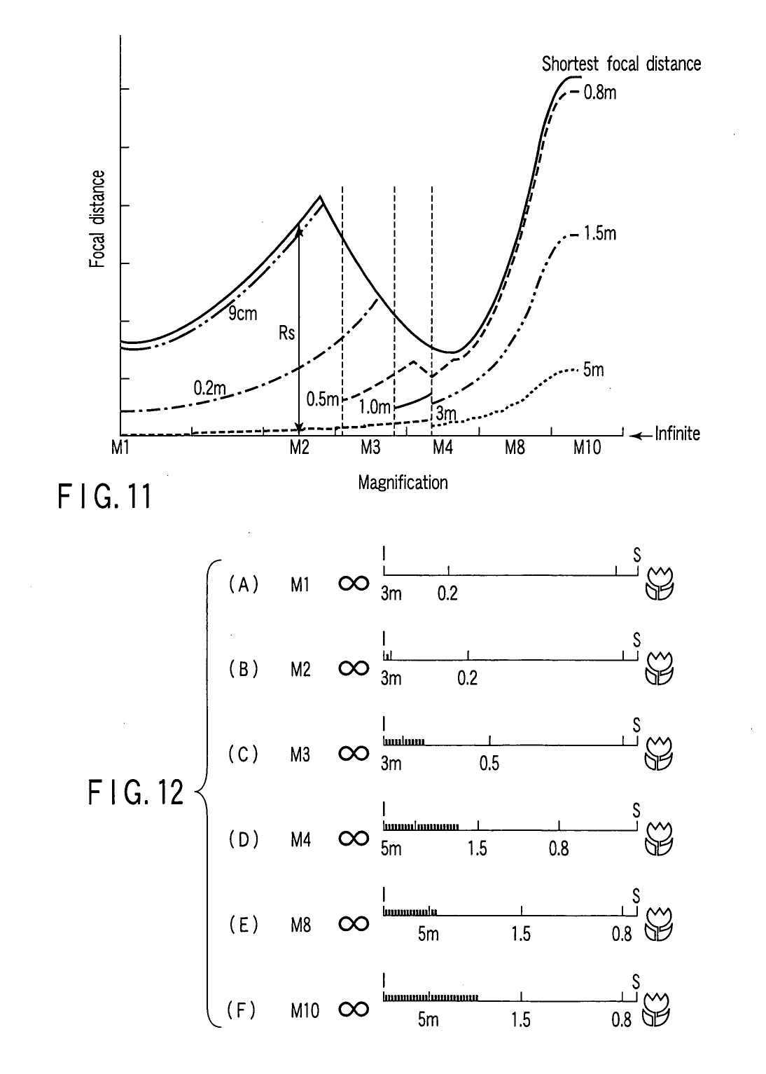

It has been described how the digital camera operates in the manual focusing mode. To help the user to change the focal distance in the manual focusing mode, a range of focal distance for the magnification selected is displayed at the focusing gauge C on the LCD 127. (The range of focal distance is a range of the distance the focusing lens 15 can be moved. The memory circuit 4 stores the data representing various ranges of focal distance, each for a specific magnification. This data will be explained with reference to FIG. 11.

In FIG. 11, the magnification, which ranges from 1 to 10, is plotted on the x axis, and the focal distance, which ranges from the infinite value to the minimum value, is plotted on the y axis. The shortest focal distance corresponds to the shortest camera-to-object distance, and the longest focal distance corresponds to the infinite camera-to-object distance. As seen from FIG. 11, the longest focal distance changes from a magnification to another magnification. For example, the longest focal distance (for the shortest camera-to-object distance) is 9 cm for the magnification of 2, and is 0.8 m for the magnification of 10. The curves for distances of 9 cm, 0.2 m, 0.5 m, 1.0 m, 1.5 m, 3 m and 5 m do not extends over the entire range of magnification (1 to 10). Each curve represents only the focal distances at which focusing can be achieved for a specific magnification. For example, the curves for focal distances 9 cm and 0.2 m do not reach the vertical line for the magnification of 3. This is because the image of the object will be out of focus at the magnification of 3 if the focal distance is set at 9 cm or 0.2 m. Thus, the object would not be photographed at magnification of 3 and the focal distance of 9 cm or 0.2 m.

To obtain an image of the object at the magnification of 2, the focal distance can be changed in range Rs. If the focusing lens 15 is moved, setting a focal distance within this range Rs, from 9 cm to the infinite, the object can be photographed at that magnification. Once a desired magnification has been selected, the focal distance range for the magnification selected is displayed at the focusing gauge C as is illustrated in FIG. 10. The gauge C will be described in detail, with reference to FIGS. 12A to 12F.

FIGS. 12A to 12F show six focal-distance scales for magnifications of 1, 2, 3, 4, 8 and 10, respectively. As can be understood from FIGS. 12A to 12F, the indicia (showing 3 m or 5 m, for example) change in position, from one magnification to another. As FIGS. 12A to 12F and FIG. 10 show, the left end I of the scale indicates the longest focal distance for the magnification selected, which corresponds to the infinite camera-to-object distance. The right end S of the scale indicates the longest focal distance for the magnification selected, which corresponds to the shortest camera-to-object distance.

As is obvious from FIGS. 12A to 12F, the focal-distance scales displayed for the different magnifications have the same length. To be more specific, the focal-distance scale for the magnification of 1, indicating a focal distance ranging from 9 cm to the infinite, is just as long as the focusing gauge for the magnification of 10, indicating a focal distance ranging from 0.8 m to the infinite. Glancing at any focal-distance scale, the camera user can quickly and unequivocally grasp not only the focal distance set, but also range Rs within which he or she can change the focal distance.

FIGS. 1 and 2 are a flowchart that illustrates a method of displaying the focusing gauge C.

Assume that the user has set the digital camera in the manual focusing mode. When the user depresses the shutter button 101 in the half-shutter mode (Step S1a), the camera starts the zooming operation (Step S2a). In the zooming operation, the first detecting unit 17 detects the position of the zooming lens 13 (Step S3a). The data representing the position is supplied to the CPU 3. From the data, the CPU 3 determines whether the zooming lens 13 has changed in position (Step S4a).

If the zooming lens 13 has changed in position, the CPU 3 serving as data-acquiring unit acquires the data representing the range Rs, within which the focusing lens 15 can move for the zoom position preset (Step S5a). More precisely, the CPU 3 acquires this data from the data stored in the form of a table in the memory circuit 4. This data is supplied to the LCD 127. The LCD 127 displays the focusing gauge C. If the zooming lens 13 has not changed in position, the CPU 3 does nothing at all (Step S6a). After acquiring the data representing the range Rs in Step S5a, the CPU 3 acquires the data representing the focal-distance scale for the magnification selected (Step S7a). This data is supplied to the LCD 127. The LCD 127 displays the focal-distance scale at the focusing gauge C already displayed.

When the CPU 3 acquires the data representing the focal-distance scale, the CPU 3 determines whether the focal distance has changed (Step S8a). If the focal distance has changed, the second detecting unit 18 detects the position that the focusing lens 15 assumes at present (Step S9a). Hence, the CPU 3 acquires the data representing the new focal-distance scale. After the unit 18 detects the position of the focusing lens 15 in Step S9a, two data items representing the new range Rs and the new focal-distance scale, respectively, are supplied to the LCD 127. The LCD 127 displays the focusing gauge C (Step S10a). In Step S8a, the CPU 3 may determine that the focal distance has not changed. In this case, too, the operation goes to Step S10a. Thus, the photographing performed in the manual focusing mode is terminated.

FIG. 3 is a flowchart that explains a method of switching the zooming to the focusing, and vice versa.

Assume that the user sets the digital camera in the manual focusing mode (Step S1b) and then depresses the shutter button 101 in the half-shutter mode (Step S2b). Thereafter, the CPU 3 determines whether the button 101 has been pushed in the full-shutter mode (Step S3b). If depressed in the full-shutter mode, the shutter button 101 is released (Step S5b). In this case, no switching is carried out between the zooming and the focusing (Step S6b).

If the CPU 3 determines, in Step S3b, that the shutter button 101 has not been pushed in the full-shutter mode, the operation goes to Step S4b. In Step S4b, the CPU 3 determines whether the camera is malfunctioning. If the camera is malfunctioning, the operation goes to Step S5b. If the camera is normally operating, the operation goes to Step S7b. In Step S7b, the CPU 3 determines whether the switching should be carried out between the zooming and the focusing. If YES in Step S7b, the operation goes to Step S5b. If NO in Step S7b, the operation goes to Step S8. In Step S8b, the shutter button 101 is released. When the shutter button 101 is released, the zooming and the focusing are switched to one another (Step S9b). In Step S9b, too, the screen is switched on the LCD 127.

In the digital camera thus configured and in the method of controlling the camera, described above, the CPU 3 acquires, from the memory circuit 4, the data representing a focal distance defining the position that the focusing lens 15 must take for the magnification selected. This data is supplied to the LCD 127, which displays a focusing gauge C and a focal-distance scale that are most appropriate to the magnification selected. The focal-distance scale enables the user to set the best possible focal distance. The CPU 3 may calculate the best possible focal distance from the position that the focusing lens 15 should take for the magnification selected.

Of the keys 7, the TELE/WIDE button 131 can be operated to perform the zooming and the manual focusing. This helps to reduce the number of keys 7. To carry out both the zooming and the manual focusing are performed to photograph an object, the user need not change hands to keep holding the digital camera. The camera is therefore easy to use.

This invention is not limited to the embodiment described above. Various changes and modifications can be made. For example, one key 7 may be assigned to the zooming only, and another key 7 to the manual focusing only, though it is not so often necessary to perform the zooming and the manual focusing at the same time. Further, the focusing gauge C and the like may be displayed on the EVF 126, not on the LCD 127 as in the above-described embodiment. Moreover, the focal-distance scale may be displayed in the form of a frame.

1. A digital camera comprising:
an optical mechanism which includes an optical zooming device having a zooming lens, and a focus-moving optical device having a focusing lens; and
a display unit configured to display a focal-distance scale that indicates a range of focal distance, which is appropriated for any magnification set by a user, one end of the focal-distance scale representing a shortest camera-to-object distance and the other end of the focal-distance scale representing an infinite camera-to-object distance.

2. A digital camera comprising:
an optical mechanism which includes an optical zooming device having a zooming lens, and a focus-moving optical device having a focusing lens;
a table which stores data;
a data-acquiring unit configured to acquire focal-distance data appropriate for a magnification set by the user, by performing calculation or in accordance with the data stored in the table; and
a display unit configured to display a focal-distance scale that indicates a focal-distance range appropriated for the magnification, by utilizing the focal-distance data.

3. A digital camera comprising:
an optical mechanism which includes an optical zooming device and a focus-moving optical device; and
a switching portion configured to switch a zooming operation to a focusing operation, and vice versa, when operated in half-shutter mode.

4. The digital camera according to claim 3, further comprising a display unit which displays data about the zooming operation or the focusing operation set by operating the switching portion.

5. A method of controlling a digital camera that comprises a display unit, and an optical mechanism including an optical zooming device and a focus-moving optical device, the method comprising:
causing the display unit to display a focal-distance scale that indicates a focal-distance range appropriated for any magnification set by a user, one end of the focal-distance scale representing a shortest camera-to-object distance and the other end of the focal-distance scale representing the infinite camera-to-object distance.

6. A method of controlling a digital camera that comprises a table storing data, a display unit, and an optical mechanism including an optical zooming device and a focus-moving optical device, the method comprising:
acquiring focal-distance data appropriate for a magnification set by the user, by performing calculation or in accordance with the data stored in the table;
acquiring data representing a focal-distance scale that indicates a focal-distance range appropriated for the magnification, by utilizing the focal-distance data; and
displaying the focal-distance scale on the display unit.

7. A method of controlling a digital camera that comprises a switching portion, and an optical mechanism including an optical zooming device and a focus-moving optical device, the method comprising:
acquiring data as to whether the switching portion has been operated in half-shutter mode; and
switching a zooming operation to a focusing operation, or vice versa, in accordance with the data acquired.

8. The method according to claim 7, wherein the digital camera comprises a display unit, and which further comprises displaying data, which represents the operation selected by the switching, on the display unit.
